(19) United States
(12) Patent Application Publication
(10) Pub. No.: US 2012/0044517 A1
(43) Pub. Date: Feb. 23, 2012

(54) IMAGE PROCESSING APPARATUS CAPABLE OF DISPLAYING SHORTCUT KEYS, AND CONTROL METHOD AND PROGRAM THEREFOR

(75) Inventor: Nobuaki FUKASAWA, Tokyo (JP)

(73) Assignee: CANON KABUSHIKI KAISHA, Tokyo (JP)

(21) Appl. No.: 13/211,387

(22) Filed: Aug. 17, 2011

(30) Foreign Application Priority Data
Aug. 19, 2010 (JP) 2010-184170

(51) Int. Cl. G06K 15/02

(52) U.S. Cl. 358/1.13

(57) ABSTRACT

An image processing apparatus prevents setting content not adapted to the capability of the image processing apparatus from being registered when registering a shortcut key for the image processing apparatus using e-mail. A user interface displays a shortcut key on a screen and allow a user to input an instruction therethrough. An execution of a function or a setting for the execution is registered onto the shortcut key. Capability information representing a capability of the apparatus itself is stored. An e-mail including content to be registered onto the shortcut key and capability information used when the user specifies the content is received. If it is determined the content included in the received e-mail should be registered onto the shortcut key based on the capability information included in the received e-mail and the stored capability information, the content included in the received e-mail is registered onto the shortcut key.

### BACKGROUND OF THE INVENTION

1. Field of the Invention

The present invention relates to an image processing apparatus capable of displaying shortcut keys, and a control method and a program therefor.

2. Description of the Related Art

Recently, as image processing apparatuses (e.g. image forming apparatus) have higher functions or more functions, there are user's needs for enabling a commonly-used function to be invoked quickly or simplifying the setting in this technical field. In response to this, an image processing apparatus is provided in which: processing related to an arbitrary function and setting is assigned to a function assignment key (i.e. shortcut key) and displayed in a displaying unit; and, when the user selects this key, the corresponding function and setting value are reflected.

In an image processing apparatus of using shortcut keys (hereinafter referred to as “the shortcut function”), functions or setting values in association with the shortcut keys are held by the image processing apparatus. When this shortcut function is utilized, it is, however, required to adjust data formats of the held functions or setting values in order to shortcut key-storable formats.

Also, the image processing function may have more functions by having installed therein an application implementing a function to be used. In this image processing apparatus, it follows that use of the shortcut function allows the function and setting value in the application to be associated with a shortcut key. In this case, if the data format of the function in the application is not inconsistent with a format adapted to the shortcut function, it is not possible to utilize the shortcut function.

This image processing apparatus copes with the above by adopting a method of storing the setting content in the application, and using the shortcut function, storing, in a key, call information including the application and pointer information for invoking the setting content.

In the case of adopting this method, when the key is pressed, the shortcut function determines the application from the call information and gives to the application the pointer information of the setting content in the call information. This application invokes the setting content from the pointer information to execute it. This method (hereinafter referred to as “the pointer scheme”) makes it possible to achieve the shortcut function without depending on the application.

It should be noted that a shortcut key is created by a user operation on an operation panel of an image processing apparatus, thereby causing the operation panel to be occupied by the user during the shortcut key creation, which disables other users to use the image processing apparatus (for a copy, for example).

Then, there is provided a network system having a conventional image processing apparatus and a host computer connected to the image processing apparatus via a network, in which exclusive application for creating shortcut key is prepared on the host computer.

The network system having this image processing apparatus causes the user to set, using the exclusive application, content of the shortcut key on the host computer, and further creates a shortcut key by transmitting the setting content to the shortcut function of the image processing apparatus via the network.

The network system having this image processing apparatus is capable of preventing a control panel from being occupied for the shortcut key creation to use the image processing apparatus for other purposes (see Japanese Laid-Open Patent Publication (Kokai) No. 2007-60425, for example).

In the network system having the above-described image processing apparatus, the host computer or the like transmits a function instruction e-mail to the image processing apparatus. The image processing apparatus having received the function instruction e-mail realizes a shortcut key function by displaying a list of the e-mail.

However, the host computer favorably generates, when creating the function instruction e-mail, the setting content of the shortcut key without figuring out the current capability of the image processing apparatus correctly, and also cannot analyze the setting content of the shortcut key by the shortcut key function even if it tries to do so, since the setting content of the shortcut key in the pointer scheme is specific to each application.

Accordingly, the host computer unfavorably transmits, to the image processing apparatus, the setting content of the shortcut key generated without figuring out the current capability of the image processing apparatus correctly.

This may disable the image processing apparatus to be operated if the received shortcut key is set as is.

Therefore, the image processing apparatus requires, when setting a received shortcut key, to actually operate the shortcut key or to make an inquiry to an application for confirmation, only for determining whether or not the setting content is correct

### SUMMARY OF THE INVENTION

The present invention provides an image processing apparatus capable of displaying shortcut keys, which prevents setting content not adapted to the capability of the image processing apparatus from being registered when registering a shortcut key for the image processing apparatus using e-mail, a control method and a program therefor.

In an aspect of the present invention, there is provided an image processing apparatus comprising: a user interface adapted to display a shortcut key on a screen and allow a user to input an instruction therethrough; a registering unit adapted to register an execution of a function or a setting for the execution onto the shortcut key; a storing unit adapted to store capability information representing a capability of the apparatus itself; a receiving unit adapted to receive an e-mail including content to be registered onto the shortcut key and capability information used when the user specifies the content to be registered; and a determining unit adapted to determine whether or not the content to be registered included in the e-mail received by the receiving unit should be registered onto the shortcut key, based on the capability information included in the e-mail received by the receiving unit and the capability information stored in the storing unit, wherein if the content to be registered included in the e-mail received by the receiving unit should be registered onto the shortcut key, the registering unit registers the content to be registered included in the e-mail received by the receiving unit onto the shortcut key.

According to the present invention, it is possible to prevent setting content not adapted to the capability of the image processing apparatus from being registered when registering a shortcut key for the image processing apparatus using e-mail.

Further features and advantages of the present invention will become apparent from the following detailed description of exemplary embodiments with reference to the attached drawings.

### BRIEF DESCRIPTION OF THE DRAWINGS

FIG. 1 is a view schematically showing a configuration of a network system including an image processing apparatus to an embodiment of the present invention.

FIG. 2 is a block diagram showing an internal configuration of a personal computer (PC) in FIG. 1.

FIG. 3 is a block diagram showing an internal configuration of the image processing apparatus (device) in FIG. 1.

FIG. 4 is a view which is useful in explaining a UI screen displayed on a user interface (UI) in FIG. 3.

FIG. 5 is a view which is useful in explaining the software configuration of the network system of FIG. 1.

FIG. 6 is a flowchart showing the procedure of a basic process of the device of FIG. 3.

FIG. 7 is a flowchart showing the procedure of an e-mail process executed in step S610 of FIG. 6.

FIG. 8 is a flowchart showing the procedure of a decoding process executed in step S711 of FIG. 7.

FIG. 9A is a view which is useful in explaining customization information described in a customization request e-mail received in step S701 of FIG. 7, and FIG. 9B is a view showing a case where the customization information in FIG. 9A is decoded.

FIG. 10 is a view which is useful in explaining capability information compared in step S713 of FIG. 7.

### DESCRIPTION OF THE EMBODIMENTS

The present invention will now be described in detail with reference to the drawings.

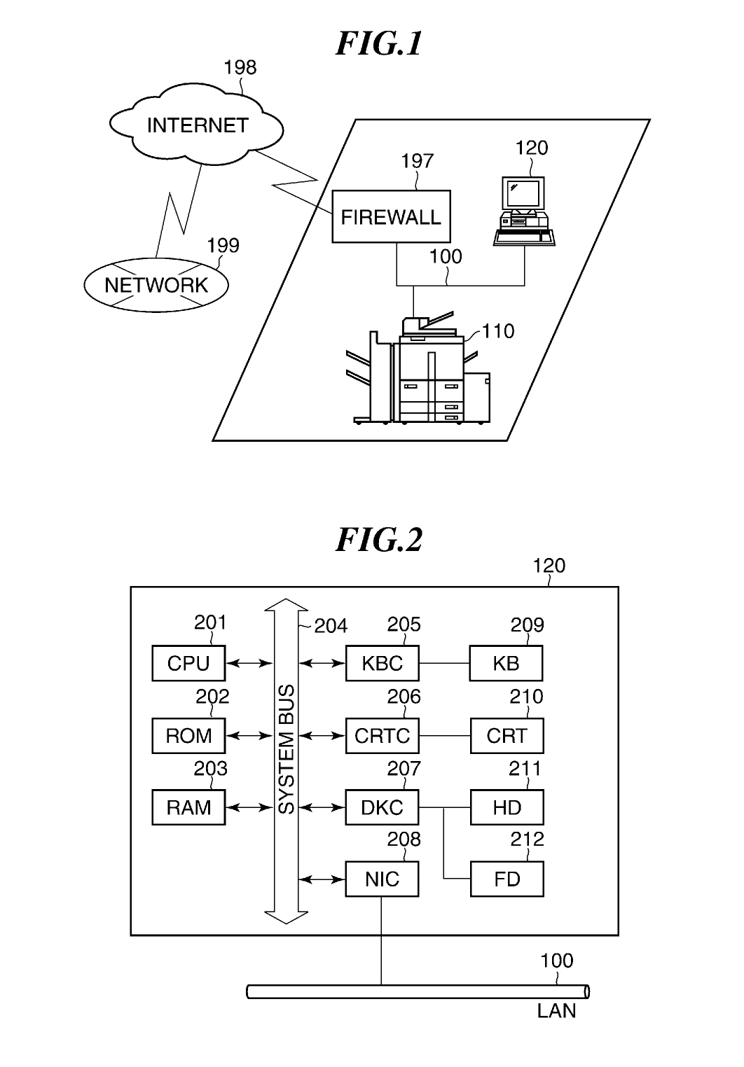

FIG. 1 is a view schematically showing a configuration of a network system including an image processing apparatus according to an embodiment of the present invention.

The network system of FIG. 1 is configured with an image processing apparatus (hereinafter referred to as “the device”) 110 and a personal computer (PC) 120 (i.e. information processing apparatus), which are connected to each other via a LAN 100. The device 110 has functions such as a copying function, a printing function, a sending function, a box storage function and a pullprint function. The devices 110 may comprise a plurality of devices 110.

The device 110 is configured to be customized by registering the settings or operations of a copy, print, image transmission and so on, for shortcut keys or switches on a UI screen.

Also, the network system of FIG. 1 is connected to an external Internet 198 via a firewall 197.

Also, the network system of FIG. 1 is connected to another network 199 via the Internet 198.

A description will next be given of examples of functions realized in the above-described network system.

The copying function of the device 110 is to read out a manuscript to convert the read out manuscript into electronic data and perform the printing, according to the user operation.

The printing function of the device 110 is to print printing data received from the PC 120, according to the user operation.

The sending function of the device 110 is to transmit the electronic data of the manuscript to the PC 120 via the LAN 100, according to the user operation. The PC 120 receives the electronic data and stores the received data.

The box storage function of the device 110 is to store the electronic data of the read out manuscript, according to the user operation.

The box sending function of the device 110 is to specify the electronic data of the manuscript stored by means of the box storage function and transmit the specified electronic data of the manuscript to the PC 120 as a destination via the LAN 100, according to a user operation. The PC 120 receives the electronic data of the manuscript and stores the received data.

The pullprint function of the device 110 is to specify the data stored in the PC 120, receive the specified data via the LAN 100, and print the received data, according to the user operation.

It should be noted that the above-described system configuration and functions are just examples, and hence the present invention is not limited thereto. The image processing apparatus, and the control method and the program of the present invention may be configured such that other devices than the above are connected to a network to provide new functions.

FIG. 2 is a block diagram showing an internal configuration of the PC 120 in FIG. 1.

In FIG. 2, the PC 120 includes a CPU 201 that takes overall control of devices connected to a system bus 204.

Further, the PC 120 includes a ROM 202, a RAM 203, a keyboard controller (KBC) 205, a CRT controller (CRTC) 206, a disk controller (DKC) 207, and a network interface card (NIC) 208, which are connected to the system bus 204 together with the CPU 201.

The RAM 203 functions as a main memory, a work area, and the like of the CPU 201. The keyboard controller (KBC) 205 controls an instruction input from a keyboard (KB) 209 or other pointing devices (not shown). The CRT controller (CRTC) 206 controls a display in a CRT display (“CRT”) 210.

The disk controller (DKC) 207 controls access to a hard disk (HD) 211. The hard disk (HD) 211 stores a boot program, various kinds of programs, various kinds of applications, edition files, user files, and so on.

The disk controller (DKC) 207 further controls access to a floppy (Registered Trademark) disk drive (FD) 212.

The network interface card (NIC) 208 performs bidirectional communication of data with a network printer, other network devices or other PCs via the LAN 100.

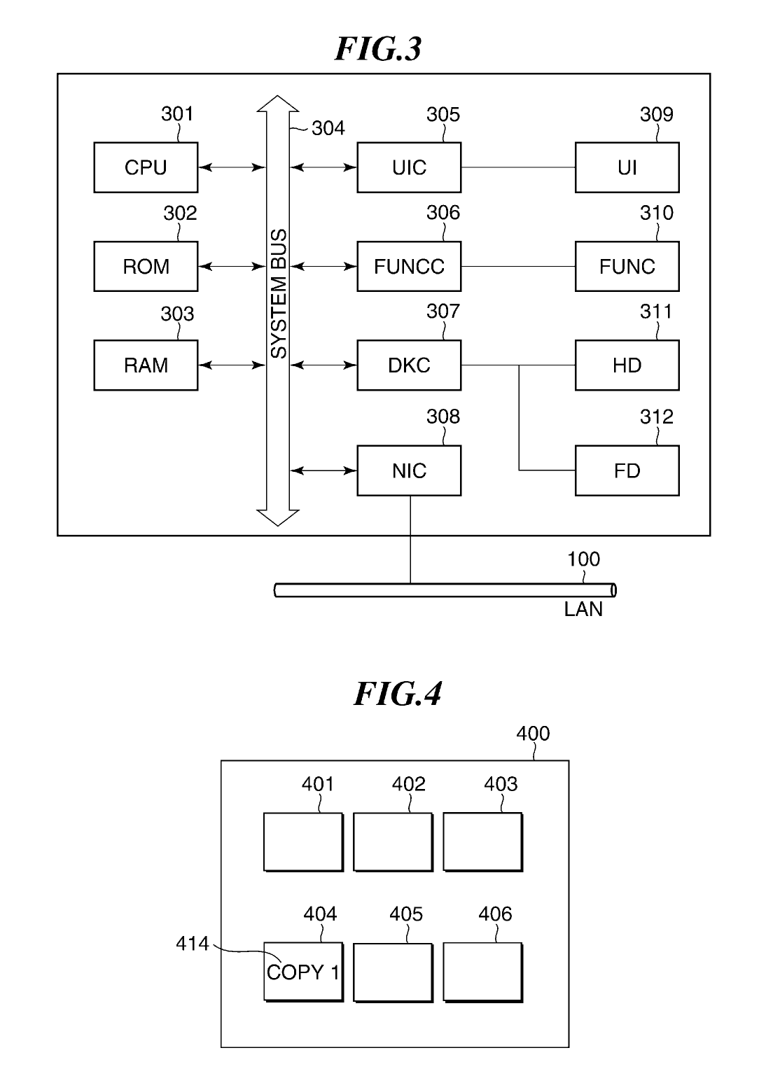

FIG. 3 is a block diagram showing an internal configuration of the image processing apparatus (device) 110 in FIG. 1.

In FIG. 3, the device 110 includes a CPU 301 that executes various programs stored in a ROM 302 or a hard disk (HD) 311 or provided from a floppy (Registered Trademark) disk drive (FD) 312. The CPU 301 takes overall control of devices connected to a system bus 304.

The device 110 further contains a RAM 303, a user interface controller (UIC) 305, a function controller (FUNCC) 306, a disk controller (DKC) 307, and a network interface card (NIC) 308, which are connected to the system bus 304 together with the CPU 301 and the ROM 302.

The RAM 303 functions as a main memory, a work area, and the like of the CPU 301.

The user interface controller (UIC) 305 manages display control in a user interface (UI) 309 and control of an instruction input from the user interface (UI) 309. The user interface (UI) 309 is configured to allow an instruction input from the user.

The function controller (FUNCC) 306 realizes/controls a device-specific function (FUNC) 310.

If the device 110 is a black and white printer, the device 110 includes a black and white print engine controller and a black and white print engine. If the device 110 is a color printer, the device 110 includes a color print engine controller and a color print engine.

Further, if the device 110 has a scan function, the device 110 includes a scanning controller and a scanner. In the case of the device 110 having a facsimile, the device 110 further includes a facsimile controller and a facsimile interface.

In short, if the device 110 has hybrid functions, the device 110 includes the FUNCC 306 and the FUNC 310 for each function.

The disk controller (DKC) 307 controls access to the hard disk (HD) 311. The hard disk (HD) 311 has functions of storing a boot program, programs to perform operations in the present embodiment, and a function as a storage area for storing various applications and data files. Further, the disk controller (DKC) 307 controls access to a floppy (Registered Trademark) disk driver (FD) 312.

The network interface card (NIC) 308 performs bidirectional communication of data with a network printer, other network devices or other PCs via the LAN 100.

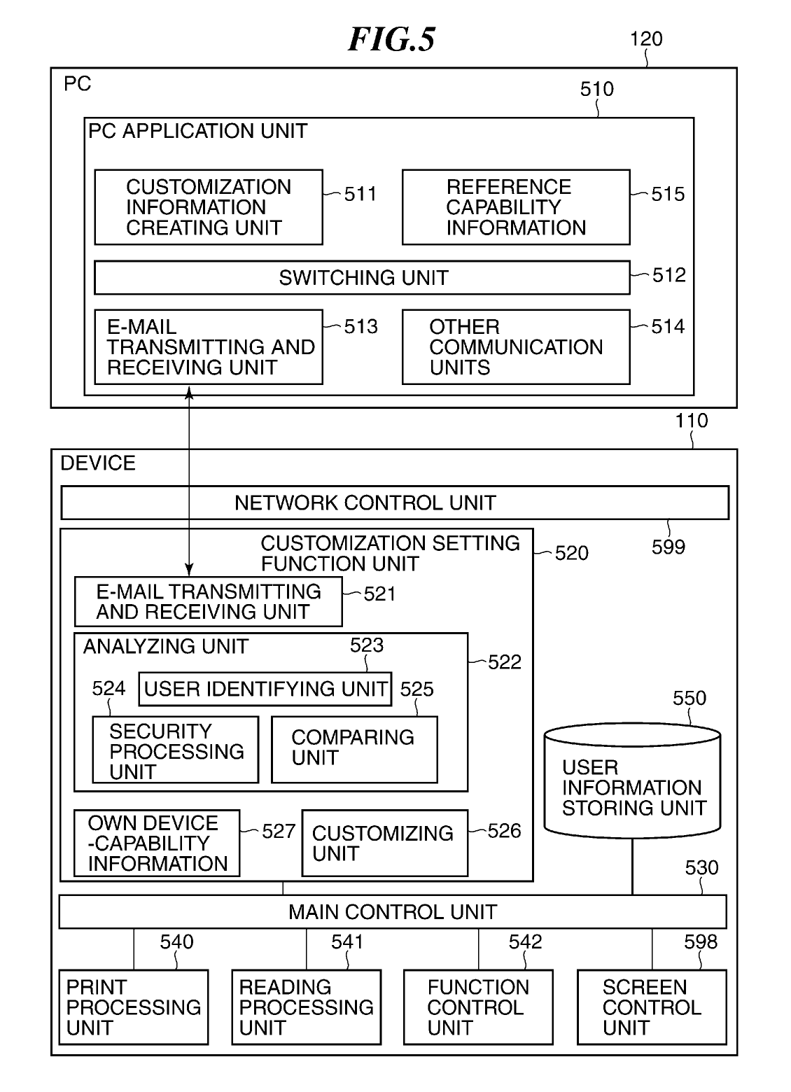

FIG. 4 is a view which is useful in explaining a UI screen displayed on the user interface (UI) 309 in FIG. 3.

In FIG. 4, the user interface (UI) 309 in the device 110 displays shortcut keys 401 to 406 on a screen 400. The device 110 has a function (i.e. shortcut key registration function) of registering, in any one of the shortcut keys 401 to 406, execution of a function provided in a network system or a setting for this execution. Further, the device 110 has a function (i.e. shortcut key execution function) of executing, when any one of the shortcut keys is pressed, the corresponding registered content.

In the device 110, for example, in order to execute the sending function, the following settings (1) to (4) are needed.

(1) To perform settings such as a resolution, designation of color/black and white, magnification, reading concentration and image quality (hereinafter referred to as “the reading settings”).

(2) To select a transmission method such as e-mail and FTP is selected.

(3) To set destination.

(4) To place a manuscript on a platen.

Also, in a case where the sending function is frequently used with the same setting, the device 110 has a function of registering the setting content in any one of the shortcut keys and executing the setting content when the any one of shortcut keys is operated.

The device 110 uses the shortcut key registration function to register the above-described settings (1) to (3) in advance in any one of the shortcut keys 401 to 406 on the screen 400.

In the device 110, when the sending function is executed, pressing the shortcut key registered by the user allows the shortcut key execution function to be performed to invoke the settings (1) to (3) with just one touch.

Accordingly, it follows that the device 110 can execute the settings (1) to (3) with just one touch, which makes it possible to simplify the user operation remarkably. After that, the user placing a manuscript on the platen enables the sending function to be started with the same setting as in the normal times described above.

If these shortcut keys 401 to 406 have settings registered therein, the setting names are displayed, as illustrated in FIG. 4, on the shortcut keys 401 to 406 in the screen 400 of the user interface (UI) 309 to thereby show the registered content for the user. FIG. 4 shows that the shortcut key 404 is displayed as “COPY 1” 414.

Also, the device 110 has a function of allowing an external apparatus to perform registration for the shortcut keys 401 to 406 in the screen 400 of the user interface (UI) 309. Specifically, in the network system illustrated in FIG. 1, a program operating in the PC 120 allows the sending function setting to be registered in the shortcut key 404 in the device 101 via the LAN 100.

FIG. 5 is a view which is useful in explaining a software configuration of the network system of FIG. 1.

In FIG. 5, according to the network system of FIG. 1, execution of a control program by the CPUs 201 and 301 disposed in the device 110 and the PC 120 realizes the functions shown in FIG. 4.

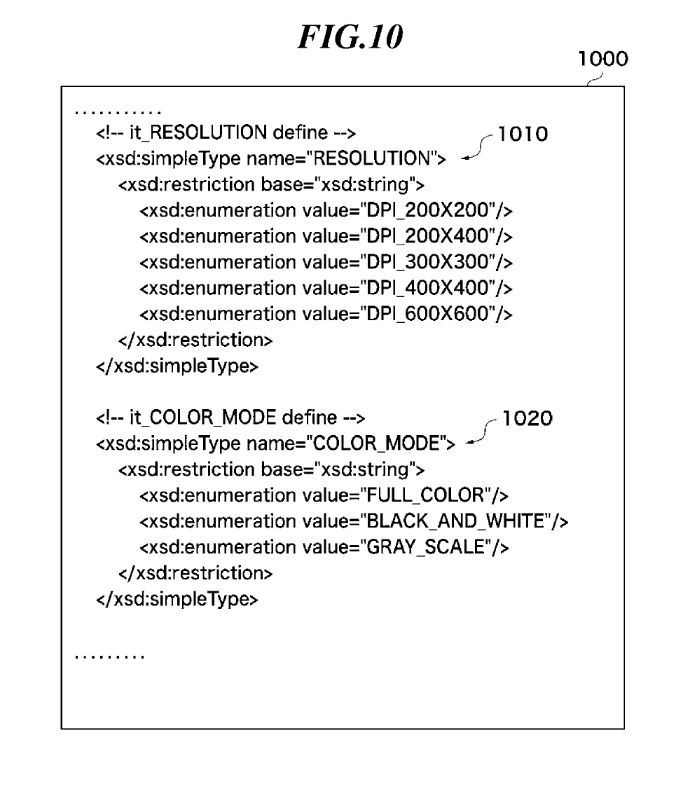

The PC 120 includes a PC application unit 510 which is configured with a customization information creating unit 511, a switching unit 512, an e-mail transmitting and receiving unit 513, other communication unit 514, and reference capability information 515 describing capability information of the device 110. The capability information will be described later using FIG. 10.

The customization information creating unit 511 generates customization information of customizing the device 110 according to the reference capability information 515 and an instruction from the user who operates the PC 120. The e-mail transmitting and receiving unit 513 transmits, when generating the generated customization information, the used reference capability information 515 to the device 110 with e-mail. Also, when receiving a reply from the device 110, the PC application unit 510 analyzes the received reply and displays the result on the UI screen of the PC 120. It should be noted that the other communication units 514 comprises other methods than e-mail, for transmitting the customization information to the device 110.

The switching unit 512 of the PC application unit 510 performs, when transmitting the customization information to the device 110, switching control between the e-mail transmitting and receiving unit 513 and the other communications units 514.

The device 110 includes a customization setting function unit 520 including an e-mail transmitting and receiving unit 521.

The e-mail transmitting and receiving unit 521 receives an e-mail including the customization information generated by the customization information creating unit 511 and the reference capability information 515 referred to when the customization information is generated. When the customization setting function unit 520 executes the customization setting, the e-mail transmitting and receiving unit 521 receives an e-mail from the PC 120 and an analyzing unit 522 analyzes its content. A user identifying unit 523 of the analyzing unit 522 identifies the user based on the “FROM” address of the received e-mail.

A security processing unit 524 of the analyzing unit 522 determines whether or not the e-mail content is encrypted, and executes, if it is encrypted, a decoding process by a unique shared key held by the identified user, and further may determine whether or not the e-mail content is tampered using a hash function.

A comparing unit 525 of the analyzing unit 522 compares an own device-capability information 527 and the reference capability information 515 described in the e-mail with each other to determine whether or not they are consistent or inconsistent with each other. The own device-capability information 527 describes the capability related to functions provided in the device 110 itself.

In the case of “consistency” as a result of the determination of the comparing unit 525, a customizing unit 526 gives the customization information described in the e-mail to a corresponding function control unit 542 and stores its pointer information in user information storing unit 550. The customization information is held in the function control unit 542.

In the case of “inconsistency” as a result of the determination of the comparing unit 525, an e-mail to describe that the customization setting is not executed because of inconsistent capability information, is created and replied from the e-mail transmitting and receiving unit 521.

The customization setting function unit 520 does not analyze the customization content in the customization processing.

For example, in the case of creating a shortcut key for the sending function described with reference to FIG. 4, the customization information (i.e. the content executed by the shortcut key) is given to the sending function as it is without analyzing the content related to the sending function.

The customizing unit 526 stores an assigned key (key 401 in this case) and the pointer information of the customization information in the user information storing unit 550, and the content executed by the shortcut key is held in the sending function.

Here, when the shortcut key is pressed by the user, the pointer information stored in the user information storing unit 550 is given to the sending function. The sending function extracts the customization information from the received pointer information and executes the customization processing.

The processing performed as above by the customization setting function unit 520 enables a customization target function (i.e. the send function in this example) and a customization function to be held independently. Further, comparing the capability information by the comparing unit 525 enables the inconsistency between the customization information and the capability of the device 110 to be detected in an easy manner.

Also, in the device 110, a print processing unit 540 executes a print process using a print engine and a reading processing unit 541 executes a reading process using a scanner. These print engine and scanner correspond to the function (FUNC) 310 in FIG. 3.

An image control unit 598 in the device 110 controls the user interface (UI) 309. A network control unit 599 controls the network interface card (NIC) 308 and realizes communication between the device 110 and other information devices (e.g. the PC 120). A main control unit 530 controls each function unit of the device 110.

It should be noted that the device 110 is naturally configured to utilize many other functions than those described above with reference to FIG. 5 and their image displaying units.

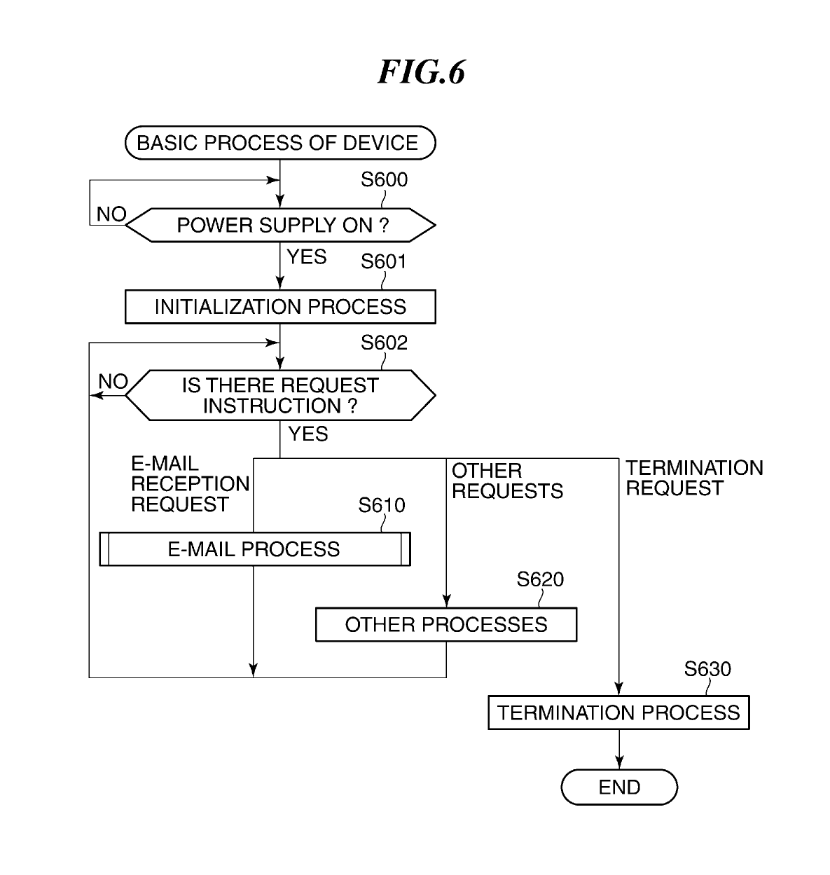

FIG. 6 is a flowchart showing the procedure of a basic process of the device of FIG. 3.

The present process is executed by the CPU 301 in the device 110.

In FIG. 6, first, if the power supply is turned on (YES to step S600), the initialization process is executed (step S601).

Next, after waiting for various request commands input by the user via the user interface (UI) 309 or various request instructions from the outside via a network, it is determined which of an e-mail reception request, another request, and a termination request is received (step S602).

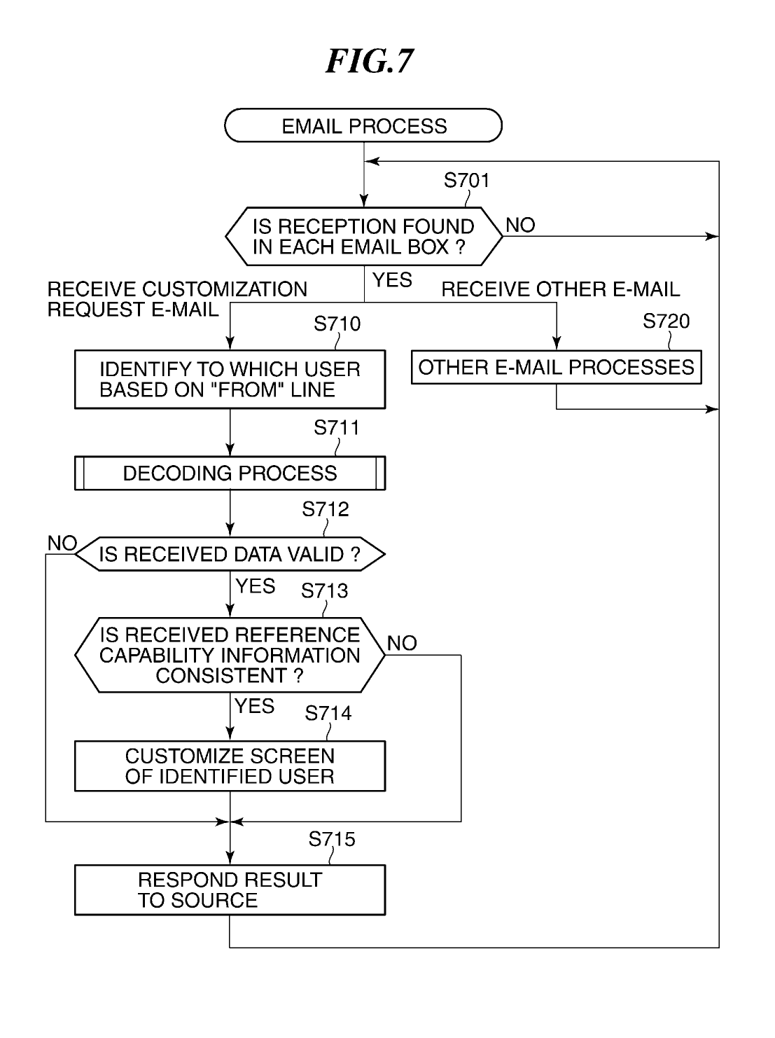

As a result of the determination of the step S602, if an e-mail reception request is received from the PC 120 (YES to the step S602), an e-mail process of FIG. 7 described later is executed, followed by returning to the step 602 to wait for a request from the PC 120 (NO to the step S602).

As a result of the determination of the step S602, a request command input by the user via the user inter (UI) 309 or a request instruction from the outside via the network is another request (YES to the step S602), the another request is executed (step S620), followed by returning to the step S602.

As a result of the determination of the step S602, a request command input by the user via the user interface (UI) 309 or a request instruction from the outside via the network (YES to the step S602), a termination process is executed (step S630), followed by terminating the present process.

FIG. 7 is a flowchart showing the procedure of an e-mail process executed in step S610 of FIG. 6.

The present process is executed by the CPU 301 in the device 110.

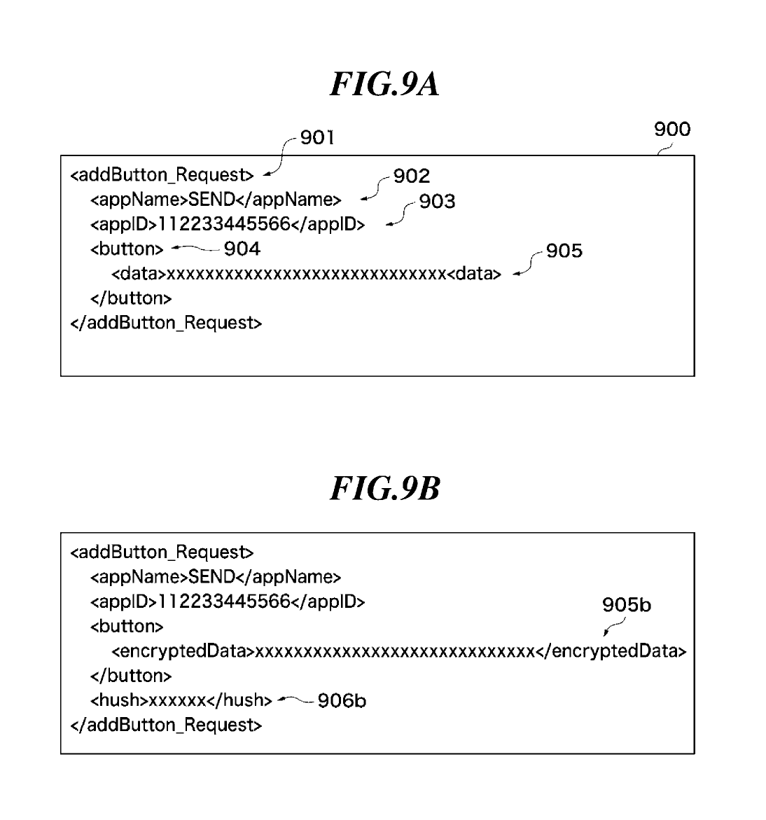

In FIG. 7, first, in each of the e-mail box receiving processes, it is determined whether or not a customization request e-mail is received or other e-mail is received (step S701). The customization request e-mail describes customization information in FIG. 9A and FIG. 9B described later.

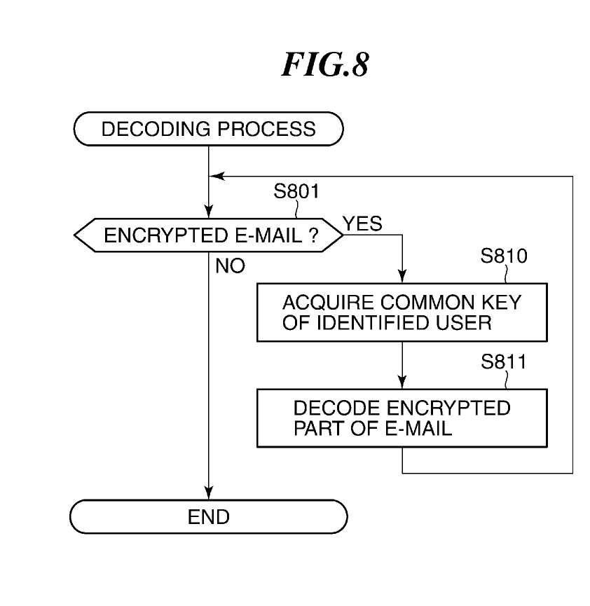

As a result of the determination of the step S701, if the customization request e-mail is received, it is identified to which user the customization request e-mail derived from the “FROM” line of the e-mail header (step S710), followed by executing the decoding process in FIG. 8 described later (step S711).

Next, it is determined whether or not the received data is valid without tampering (step S712), and, if it is valid without tampering (YES to the step 712), the reference capability information 515 described in the received e-mail and the own device-capability information 527 are compared with each other (step S713). The reference capability information 515 and the own device capability information 527 will be described in detail using FIG. 10.

As a result of the comparison of the step S713, if the reference capability information 515 described in the received e-mail and the own device-capability information 527 are consistent with each other, the identified user is customized according to information of the received e-mail (step S714). That is, the user information 550 is set according to customization information is executed. For example, as shown in FIG. 4, a user-specific shortcut key is generated.

After the process of the step S714 has been executed or if the received data is not valid with tampering (NO to the step S712), or if the reference capability information 515 described in the received e-mail and the own device-capability information 527 are inconsistent with each other (NO to the step S713), the result is replied to the source without generating a shortcut key (step S715), followed by terminating the process.

According to the process of FIG. 7, in a case where the received data is valid without tampering (YES to the step S712) and the received reference capability information 515 and the own device-capability information 527 are consistent with each other (YES to the step S713), the results and the success of customization are described in an e-mail to reply to the source (step S715).

In contrast, in a case where the received data is not valid with tampering (NO to the step S712), or the received reference capability information 515 and the own device-capability information 527 are inconsistent with each other (NO to the step S713), the result and the failure of customization are described in an e-mail to reply to the source (step S715).

After the process of the step S715, the process returns to the step S701 again to wait until an e-mail is transmitted to e-mail boxes.

As a result of the determination of the step S701, if an e-mail other than a customization request e-mail is received, other e-mail process is executed (step S720), followed by returning to the step S701.

FIG. 8 is a flowchart showing the procedure of a decoding process executed in step S711 of FIG. 7.

The present process is executed by the CPU 301 in the device 110.

In FIG. 8, first, it is determined, based on contents described in the customization request e-mail, whether or not the received e-mail is an encryption e-mail, requiring the decoding process (step S801).

As a result of the determination of the step S801, if the received e-mail is an encryption e-mail, a common key held by the user identified in the step S710 is acquired from the user information 550 (step S810) and subsequently an encrypted part of the encryption e-mail is decoded using the common key acquired in the step S810 (step S811), followed by returning to the step S801.

As a result of the determination of the step S801, if the received e-mail is not an encryption e-mail (NO to the step S801), the process immediately terminates.

FIG. 9A is a view which is useful in explaining customization information described in a customization request e-mail received in the step S701 of FIG. 7, and FIG. 9B is a view showing a case where the customization information in FIG. 9A is decoded.

In FIG. 9A, a tag 901 shows that the customization request e-mail is directed to a request of generating the shortcut key in FIG. 4. A tag 902 shows that an application assigned to the shortcut key is directed to a sending function. A tag 903 shows information of an application ID as an identifier of the sending function. A tag 904 shows setting content of the shortcut key in FIG. 4, where the setting value is displayed to be surrounded by a tag 905.

This customization information is, when encrypted, displayed as shown in FIG. 9B. FIG. 9B is different from FIG. 9A in tag 905b, 906b. In FIG. 9B, the tag 905b shows that the setting content of the shortcut key is encrypted, and the tag 906b shows the result obtained by inputting the tags 902 to 904, and 905 in a hash function.

The value of the tag 906b and the result of decoding the tags 902 to 904, and 905 using the user-specific common key and inputting decoded tags 902 to 904, and 905 in the hash function are targeted for comparison to check data tampering in the step S712 of FIG. 7. This comparison result is used to check the validity of the shortcut key setting content. This validity check shows that, if the comparison result of the input realizes consistency, the data is valid without tampering; if not, the data is tampered.

FIG. 10 is a view which is useful in explaining capability information compared in the step S713 of FIG. 7.

In FIG. 10, a tag 1010 shows a range of settable resolutions, and shows that the range includes 200×200 dpi, 200×400 dpi, 300×300 dpi, 400×400 dpi and 600×600 dpi.

In FIG. 10, a tag 1020 shows a range of settable color modes, and shows that the range includes full color, black and white and gray scale. It should be noted that FIG. 10 merely shows two examples, and hence the device 110 according to the present embodiment may include many other items of capability information.

In short, in a network system having this image processing apparatus, the user operates a personal computer to execute customization by utilizing a shortcut key registration function of the image processing device connected to each other via the network.

The PC 120 includes the reference capability information 515, which is capability information specific to each device 110 as image processing apparatuses targeted for customization, the customization information creating unit 511 and the e-mail transmitting and receiving unit 512.

A control unit of the PC 120 uses its PC application to make the customization information creating unit 511 set customization information based on the reference capability information specific to each device 110 according to a user input command. Further, the control unit of the PC 120 makes the e-mail transmitting and receiving unit 512 transmit an e-mail including the generated customization information and the used reference capability information to the device 110. It should be noted that the PC 120 is capable of transmitting and receiving the e-mail with the e-mail with e-mail encrypted.

The device 110 of operated target, having received the e-mail including the customization information and the reference capability information from the PC 120, includes a shortcut key registration function and various functions such as a copy function. Further, the device 110 includes the screen 400 of the user interface (UI) 309, the e-mail transmitting and receiving unit 521, the analyzing unit 522, the user identifying unit 523, and the customization setting function 520 by e-mail. In addition, the device 110 includes the own device-capability information 527, the comparing unit 525, the security processing unit 524, and a content determination function utilizing a hush function and so on.

A control unit of the device 110 reads the customization information and the reference capability information from the received e-mail. In addition, the control unit of the device 110 specifies a user interface of the customization target (i.e. a transmitter from the PC 120) in the user identifying unit 523.

Further, if it is determined that the comparing unit 525 of the device 110 compares the received reference capability information and the own device-capability information 527 with each other. Then, if the consistency is realized, the control unit of the device 110 makes the customization setting function 520 execute a customization setting process based on the customization information for the specified user interface. In association with this, the control unit of the device 110 transmits a response e-mail of “customization normal completion” to the PC 120.

In contrast, if it is determined that the reference capability information received in the comparing unit 525 and the own device-capability information 527 are inconsistent with each other, the control unit of the device 110 does not execute a screen customization process. In association with this, the e-mail transmitting and receiving unit 521 in the device 110 transmits a response e-mail of “error” to the PC 120.

Next, a case will be explained where e-mail content is encrypted and then transmitted and received between the PC 120 and the device 110. In this case, the received e-mail is encrypted, and therefore the control unit of the device 110 determines whether or not information decoding is necessary.

If it is determined that decoding is necessary, a common key of the user identified in the user identifying unit 523 is specified. Then, the control unit of the device 110 makes the security processing unit 524 use this common key to decode the customization information and the reference capability information.

Further, based on the content determination function utilizing the hush function and so on, the control unit of the device 110 determines the validity of content of the decoded customization information and the reference capability information.

Then, if the validity is determined to be realized, the comparing unit 525 of the device 110 compares the reference capability information and the own device-capability information. Then, if the consistency is realized, the control unit of the device 110 makes the customization setting function 520 execute a customization setting process based on the customization information for the specified user interface. In association with this, the control unit of the device 110 transmits a response e-mail of “customization normal completion” to the PC 120.

In contrast, based on the content determination function utilizing the hush function and so on, if the control unit of the device 110 determines that content of the decoded customization information and the reference capability information is invalid, it does not execute the screen customization process.

Further, if the comparing unit 525 of the device 110 determines that the received reference capability information and the own device-capability information 527 are inconsistent with each other, the control unit of the device 110 does not execute the screen customization process.

In association with this, even if there is not executed any one of the screen customization processes described above, the device 110 makes the e-mail transmitting and receiving unit 521 transmit a response e-mail of “error” to the PC 120.

Therefore, the user intending to customize the user interface of the device 110 can check whether the customization succeeds or the customization fails using the PC 120. Further, if the customization succeeds, operating a shortcut key on the UI screen of the device 110 makes it possible to provide reassurance to the user that a function set in the shortcut key is reliably operated.

The user executes a customization process of the device 110 via the Internet using the PC 120, so that other uses can utilize a copy function and so on of the device 110 during this customization process, which improves the convenience.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Applications No. 2010-184170, filed Aug. 19, 2010, which is hereby incorporated by reference herein in its entirety.

What is claimed is:

1. An image processing apparatus comprising:
a user interface adapted to display a shortcut key on a screen and allow a user to input an instruction therethrough;
a registering unit adapted to register an execution of a function or a setting for the execution onto the shortcut key;
a storing unit adapted to store capability information representing a capability of the apparatus itself;
a receiving unit adapted to receive an e-mail including content to be registered onto the shortcut key and capability information used when the user specifies the content to be registered; and
a determining unit adapted to determine whether or not the content to be registered included in the e-mail received by said receiving unit should be registered onto the shortcut key, based on the capability information included in the e-mail received by said receiving unit and the capability information stored in said storing unit,
wherein if the content to be registered included in the e-mail received by said receiving unit should be registered onto the shortcut key, said registering unit registers the content to be registered included in the e-mail received by said receiving unit onto the shortcut key.

2. The image processing apparatus according to claim 1, wherein if the capability information included in the e-mail received by said receiving unit is consistent with the capability information stored in said storing unit, said determining unit determines that the content to be registered included in the e-mail received by said receiving unit should be registered onto the shortcut key.

3. The image processing apparatus according to claim 1, further comprising a reporting unit adapted to report, if the content to be registered included in the e-mail received by said receiving unit is registered onto the shortcut key, a success of registration to a transmission source of the e-mail received by said receiving unit.

4. The image processing apparatus according to claim 1, further comprising a decoding unit adapted to decode the content to be registered if the content to be registered included in the e-mail received in said receiving unit is encrypted.

5. The image processing apparatus according to claim 1, wherein the content to be registered onto the shortcut key relates to a print function of printing image data.

6. The image processing apparatus according to claim 1, wherein the content to be registered onto the shortcut key relates to a transmission function of transmitting image data.

7. A control method for an image processing apparatus comprising a user interface adapted to display a shortcut key on a screen and allow a user to input an instruction therethrough, the control method comprising:
a registering step of registering an execution of a function or a setting for the execution onto the shortcut key;
a storing step of storing capability information representing a capability of the apparatus itself;
a receiving step of receiving an e-mail including content to be registered onto the shortcut key and capability information used when the user specifies the content to be registered; and
a determining step of determining whether or not the content to be registered included in the e-mail received in said receiving step should be registered onto the shortcut key, based on the capability information included in the e-mail received by said receiving step and the capability information stored in said storing unit,
wherein if the content to be registered included in the e-mail received in said receiving step should be registered onto the shortcut key, said registering step comprises registering the content to be registered included in the e-mail received in said receiving step onto the shortcut key.

8. A non-transitory computer readable storage medium storing a program for causing a computer to execute the control method according to claim 7.
